(19) United States
(12) Patent Application Publication
(10) Pub. No.: US 2016/0146123 A1
(43) Pub. Date: May 26, 2016

(54) FUEL SWITCHING CONTROL METHOD FOR BI-FUEL VEHICLE

(71) Applicant: HYUNDAI MOTOR COMPANY, Seoul (KR)

(72) Inventor: YOO JIN SEO, Hwaseong-Si (KR)

(21) Appl. No.: 14/678,719

(22) Filed: Apr. 3, 2015

(30) Foreign Application Priority Data
Nov. 25, 2014 (KR) 10-2014-0165151

(51) Int. Cl. F02D 19/06

(52) U.S. Cl. CPC F02D 19/0615; F02D 19/0628; F02D 19/0647; F02D 19/0665; F02D 19/0684

(57) ABSTRACT

A fuel switching control method for a bi-fuel vehicle includes a residual fuel amount measurement step measuring a first fuel level. A fuel amount comparison step checks whether the measured first fuel amount is lower than a first reference value. A fuel injection amount comparison step checks whether an accumulated amount of injected fuel is lower than a second reference value. A mileage comparison step checks whether the accumulated mileage is lower than a third reference value. A pressure comparison step checks whether pressures in a first fuel supply rail and first fuel tank are higher than fourth and fifth reference values, respectively. A pressure variation comparison step checks whether pressure variations in the first fuel supply rail and first fuel tank are lower than sixth and seventh reference values, respectively. A second fuel mode drive step switches from a first fuel mode to a second fuel mode.

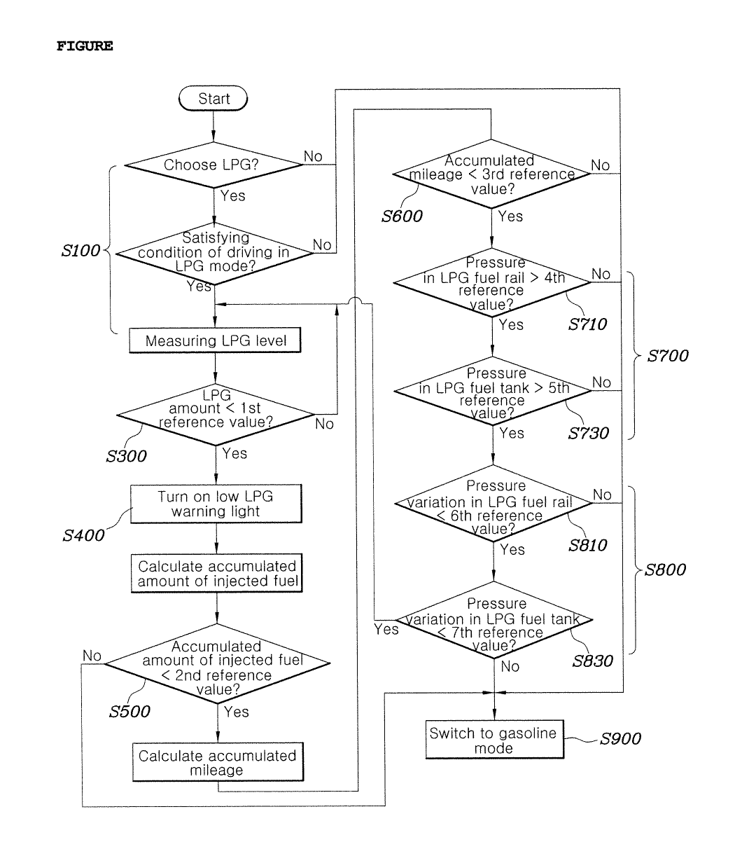

### CROSS REFERENCE TO RELATED APPLICATION

The present application claims the benefit of priority to Korean Patent Application Number 10-2014-0165151 filed on Nov. 25, 2014, the entire content of which application is incorporated herein for all purposes by this reference.

### TECHNICAL FIELD

The present disclosure relates to a fuel switching control method for a bi-fuel vehicle that allows driving the vehicle using a lower cost fuel among two or more fuels.

### BACKGROUND

In a vehicle using two or more fuels, a driver may manually choose a fuel, or the fuel being used may be automatically changed to another fuel according to driving conditions.

For example, in case of a liquefied petroleum gas (LPG)—gasoline bi-fuel vehicle, parts such as a vaporizer, a mixer, an LPG bombe, and the like are additionally installed to use LPG. Accordingly, a driver may choose between use of gasoline or LPG.

In case of a mono-fuel vehicle, the driver may continue driving the vehicle even after a driver detects a low fuel warning such that there is a high risk of engine shut down due to depletion of the fuel. On the other hand, the driver of the bi-fuel vehicle can completely consume the LPG fuel, which is cheaper, until a fuel level reaches a minimum threshold range.

To prepare for a safety problem such as the engine shut down while driving, an engine control unit (ECU) allows the use of LPG within a range where the fuel level may be measured by a level sensor of an LPG fuel tank. Accordingly, when the fuel level reaches a measurable minimum value, the ECU automatically switches the fuel to gasoline.

Accordingly, a fuel switching control method for a bi-fuel vehicle is necessary for driving the vehicle in an LPG mode rather than a gasoline mode, and for switching from LPG to gasoline after the LPG stored in a fuel tank (bombe) falls below a minimum threshold level.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems, and an aspect of the present inventive concept provides a fuel switching control method for a bi-fuel vehicle that allows a driver to drive the vehicle in an LPG mode rather than a gasoline mode, and to switch from LPG to gasoline after the LPG stored in a fuel tank (bombe) falls below a minimum threshold level.

A fuel switching control method for a bi-fuel vehicle according to the present disclosure includes a residual fuel amount measurement step that measures an amount of a first fuel when a first fuel mode is selected and driving conditions for using the first fuel are satisfied. A fuel amount comparison step checks whether the first fuel amount measured in the residual fuel amount measurement step is lower than a first reference value, after the residual fuel amount measurement step. A fuel injection amount comparison step calculates an accumulated amount of the first fuel injected and checks whether the accumulated amount is lower than a second reference value, after the fuel amount comparison step. A mileage comparison step calculates an accumulated mileage of the vehicle and checks whether the mileage is lower than a third reference value, after the fuel injection amount comparison step. A pressure comparison step checks whether pressures in a fuel supply rail for the first fuel and in a fuel tank for the first fuel are the same as or higher than fourth and fifth reference values, respectively, after the mileage comparison step. A pressure variation comparison step checks whether pressure variations in the fuel supply rail for the first fuel and in the fuel tank for the first fuel are lower than sixth and seventh reference values, after the pressure comparison step. A second fuel mode drive step switches the first fuel mode to a second fuel mode to drive the vehicle in the second fuel mode.

In the residual fuel amount measurement step, if the driving conditions for using the first fuel are not satisfied, the second fuel mode drive step may switch the first fuel mode to the second fuel mode to drive the vehicle in the second fuel mode.

In the fuel amount comparison step, if the measured amount of the first fuel is lower than the first reference value, a warning step may turn on a low fuel warning light.

In the fuel amount comparison step, if the measured amount of the first fuel is the first reference value or higher, the amount of the first fuel may be repeatedly measured.

In the fuel injection amount comparison step, if the accumulated amount of the injected first fuel is the second reference value or higher, the second fuel mode drive step may switch the first fuel mode to the second fuel mode to drive the vehicle in the second fuel mode.

In the mileage comparison step, if the accumulated mileage of the vehicle is the third reference value or higher, the second fuel mode drive step may switch the first fuel mode to the second fuel mode to drive the vehicle in the second fuel mode.

In the pressure comparison step, a rail pressure comparison step is performed to check whether the pressure in the fuel supply rail for the first fuel is the fourth reference value or higher, and if the rail pressure is the fourth reference value or higher, a tank pressure comparison step may be performed to check whether the pressure in the fuel tank is the fifth reference value or higher.

In the rail pressure comparison step, if the pressure in the fuel supply rail of the first fuel is lower than the fourth reference value, the second fuel mode drive step may switch the first fuel mode to the second fuel mode to drive the vehicle in the second fuel mode.

In the tank pressure comparison step, if the pressure in the fuel tank of the first fuel is lower than the fifth reference value, the second fuel mode drive step may switch the first fuel mode to the second fuel mode to drive the vehicle in the second fuel mode.

In the pressure variation comparison step, a rail pressure variation comparison step is performed to check whether the pressure variation in the fuel supply rail is lower than the sixth reference value, and if the pressure variation in the fuel supply rail is lower than the sixth reference value, a tank pressure variation comparison step may be performed to check whether the pressure variation in the fuel tank is lower than the seventh reference value.

In the rail pressure variation comparison step, if the pressure variation in the fuel supply rail of the first fuel is the sixth reference value or higher, the second fuel mode drive step may switch the first fuel mode to the second fuel mode to drive the vehicle in the second fuel mode.

In the tank pressure variation comparison step, if the pressure variation in the fuel tank of the first fuel is the seventh reference value or higher, the second fuel mode drive step may switch the first fuel mode to the second fuel mode to drive the vehicle in the second fuel mode.

In the pressure variation comparison step, if the pressure variations in the fuel supply rail for the first fuel and in the fuel tank for the first fuel are lower than the sixth and seventh reference values, respectively, the residual fuel amount measurement step may be repetitively performed. The first fuel is LPG, and the second fuel is gasoline.

According to the fuel switching control method for a bi-fuel vehicle as described above, pressures in both an LPG fuel rail and a fuel tank are monitored, and thus, it is possible to indirectly determine an actual fuel amount remaining in the fuel tank. Further, the vehicle may be driven in the LPG mode as far as possible by calculating the absolute value and variation of the pressures.

A driver of the bi-fuel vehicle may drive the vehicle using cheaper fuel such as LPG even when the residual amount of the fuel is lower than a value measurable by a fuel level sensor. Furthermore, even though the level sensor of LPG fuel malfunctions, the driver may drive the vehicle in the LPG mode using the fuel pressure. Therefore, merchantability of the vehicle may be improved by satisfying customers.

In addition, the cost for the sensor may be reduced by demounting the level sensor of the LPG fuel tank.

### BRIEF DESCRIPTION OF THE DRAWINGS

The above and other objects, features and other advantages of the present disclosure will be more clearly understood from the following detailed description taken in conjunction with the accompanying drawing.

The FIGURE is a flow diagram illustrating a fuel switching control method for a bi-fuel vehicle according to an embodiment of the present inventive concept.

### DETAILED DESCRIPTION

Hereinafter, a fuel switching control method for a bi-fuel vehicle according to an embodiment of the present inventive concept will be described referring to accompanying drawings.

The FIGURE is a flow diagram illustrating a fuel switching control method for a bi-fuel vehicle according to an embodiment of the present inventive concept. The fuel switching control method for a bi-fuel vehicle according to an embodiment of the present inventive concept includes a residual fuel amount measurement step (S100) that measures a level of a first fuel when a first fuel mode is selected, and conditions for using the first fuel are satisfied. A fuel amount comparison step (S300) checks whether the amount of the first fuel measured in the residual fuel amount measurement step (S100) is lower than a first reference value. A fuel injection amount comparison step (S500) calculates an accumulated amount of the injected first fuel and checks whether the accumulated amount is lower than a second reference value after the fuel amount comparison step (S300). A mileage comparison step (S600) calculates an accumulated mileage of the vehicle and checks whether the mileage is lower than a third reference value after the fuel injection amount comparison step (S500). A pressure comparison step (S700) checks whether pressures in a fuel supply rail for the first fuel and in a fuel tank for the first fuel are higher than fourth and fifth reference values after the mileage comparison step (S600). A pressure variation comparison step (S800) checks whether pressure variations in the fuel supply rail for the first fuel and in the fuel tank for the first fuel are lower than sixth and seventh reference values after the pressure comparison step (S700). A second fuel mode drive step (S900) switches the mode to a second fuel mode and then drives the vehicle.

Described herein is an example in which the first fuel is LPG and the second fuel is gasoline.

First, after detecting that a driver has chosen an LPG mode, the residual fuel amount measurement step (S100) checks whether the conditions excluding a coolant temperature are satisfied for driving in the LPG mode. In this case, when the conditions are not satisfied for driving in the LPG mode, the second fuel mode drive step (S900) is performed to switch the mode to a gasoline mode, which is the second fuel mode, and to drive the vehicle in the gasoline mode.

In the residual fuel amount measurement step)(S100), if the conditions excluding the coolant temperature are satisfied for driving in the LPG mode, a fuel amount level of LPG is measured. Then, the fuel amount comparison step (S300) is performed to check whether the measured amount of LPG is lower than the first reference value that was previously input to a controller.

In the fuel amount comparison step (S300), if the measured amount of LPG is the first reference value or higher, the level of LPG is repeatedly measured. On the contrary, if the measured amount of LPG is lower than the first reference value, a warning step (S400) is performed to turn on a low fuel warning light.

After the fuel amount comparison step (S300), the fuel injection amount comparison step (S500) is performed to calculate the accumulated amount of injected LPG and to check whether the accumulated amount is the second reference value or higher. If the accumulated amount of the injected LPG is the same as or higher than the second reference value that is previously input to the controller, the second fuel mode drive step (S900) is performed to switch the mode to the gasoline mode and then to drive the vehicle.

However, if the accumulated amount of the injected fuel is lower than the second reference value, the mileage comparison (S600) is performed to calculate the accumulated mileage and to compare it with the third reference value. The mileage comparison step (S600) calculates the accumulated mileage of the vehicle and checks whether the mileage is the third reference value or higher. If the accumulated mileage of the vehicle is the same as or higher than the third reference value that is previously input to the controller, the second fuel mode drive step (S900) is performed to switch the mode to a gasoline mode and then to drive the vehicle. On the contrary, if the accumulated mileage of the vehicle is lower than the third reference value, the pressure comparison step (S700) is performed.

After the mileage comparison step (S600), the pressure comparison step (S700) is performed to check whether pressures in the fuel supply rail for LPG and in the fuel tank for LPG are lower than fourth and fifth reference values, respectively, that were previously input to the controller. In the pressure comparison step (S700), a rail pressure comparison step (S710) is performed to check whether the pressure in the fuel supply rail for LPG is the fourth reference value or higher. If the pressure in the rail is the same as or higher than the fourth reference value, a tank pressure comparison step (S730) is performed to check whether the pressure in the fuel tank is the fifth reference value or higher. However, in the rail pressure comparison step (S710), if the pressure in the fuel supply rail is lower than the fourth reference value, the second fuel mode drive step (S900) is performed to switch the mode to the second fuel mode and then to drive the vehicle. In the tank pressure comparison step (S730), if the pressure in the fuel tank of LPG is lower than the fifth reference value, the second fuel mode drive step (S900) is performed to switch the mode to the second fuel mode and then to drive the vehicle. On the contrary, if the pressure in the fuel tank of LPG is the fifth reference value or higher, the pressure variation comparison step (S800) is performed.

After the pressure comparison step (S700), the pressure variation comparison step (S800) is performed to check whether pressure variations in the fuel supply rail for the first fuel and in the fuel tank for the first fuel are the same as or higher than the sixth and seventh reference values. In the pressure variation comparison step (S800), if the pressure variations in the fuel supply rail for the first fuel and in the fuel tank for the first fuel are lower than the sixth and seventh reference values, the residual fuel amount measurement step (S100) is repeatedly performed. In the pressure variation comparison step (S800), a rail pressure variation comparison step (S810) is performed to check whether the pressure variation in the fuel supply rail for the first fuel is lower than the sixth reference value. If the pressure variation in the fuel supply rail is lower than the sixth reference value, a tank pressure variation comparison step (S830) is performed to check whether the pressure variation in the fuel tank is lower than the seventh reference value. In the rail pressure variation comparison step (S810), if the pressure variation in the fuel supply rail for the first fuel is the sixth reference value or higher, the second fuel mode drive step (S900) is performed to switch the mode to the second fuel mode and then to drive the vehicle. In the tank pressure variation comparison step (S830), if the pressure variation in the fuel tank for the first fuel is the seventh pressure or higher, the second fuel mode drive step (S900) is performed to switch the mode to the second fuel mode and then to drive the vehicle.

Accordingly, as the fuel switching control method for a bi-fuel vehicle described above monitors the pressures in both the LPG fuel rail and the LPG fuel tank, it is possible to indirectly determine an actual amount of fuel remaining in the fuel tank using the two pressure values. Further, the method enables driving the vehicle in the LPG mode as far as possible by calculating absolute value and variation of the pressure.

Consequently, a driver of the bi-fuel vehicle may drive the vehicle using cheap LPG even when the fuel level is lower than the value measurable by the fuel level sensor. In addition, when the LPG fuel level sensor malfunctions, the vehicle is driven in the LPG mode using the fuel pressure. Therefore, merchantability of the vehicle may be improved, and it is possible to satisfy customers.

Furthermore, as the vehicle may not require installation of the fuel level sensor of the LPG fuel tank, cost may be reduced.

Although the exemplary embodiment of the present inventive concept has been disclosed for illustrative purposes, those skilled in the art will appreciate that various modifications, additions and substitutions are possible, without departing from the scope and spirit of the disclosure as disclosed in the accompanying claims.

What is claimed is:

1. A fuel switching control method for a bi-fuel vehicle, comprising:
a residual fuel amount measurement step that measures an amount of a first fuel when a first fuel mode is selected and driving conditions for using the first fuel are satisfied;
a fuel amount comparison step that checks whether the first fuel amount measured in the residual fuel amount measurement step is lower than a first reference value, after the residual fuel amount measurement step;
a fuel injection amount comparison step that calculates an accumulated amount of the first fuel injected and checks whether the accumulated amount is lower than a second reference value, after the fuel amount comparison step;
a mileage comparison step that calculates an accumulated mileage of the vehicle and checks whether the accumulated mileage is lower than a third reference value, after the fuel injection amount comparison step;
a pressure comparison step that checks whether pressures in a fuel supply rail for the first fuel and in a fuel tank for the first fuel are the same as or higher than fourth and fifth reference values, respectively, after the mileage comparison step;
a pressure variation comparison step that checks whether pressure variations in the fuel supply rail for the first fuel and in the fuel tank for the first fuel are lower than sixth and seventh reference values, respectively, after the pressure comparison step; and
a second fuel mode drive step that switches the first fuel mode to a second fuel mode to drive the vehicle in the second fuel mode.

2. The method of claim 1, wherein in the residual fuel amount measurement step, if the driving conditions for using the first fuel are not satisfied, the second fuel mode drive step switches the first fuel mode to the second fuel mode to drive the vehicle in the second fuel mode.

3. The method of claim 1, further comprising a warning step that turns on a low fuel warning light if the measured amount of the first fuel is lower than the first reference value in the fuel amount comparison step.

4. The method of claim 1, wherein in the fuel amount comparison step, if the measured amount of the first fuel is the first reference value or higher, the amount of the first fuel is repeatedly measured.

5. The method of claim 1, wherein in the fuel injection amount comparison step, if the accumulated amount of the injected first fuel is the second reference value or higher, the second fuel mode drive step switches the first fuel mode to the second fuel mode to drive the vehicle in the second fuel mode.

6. The method of claim 1, wherein in the mileage comparison step, if the accumulated mileage is the third reference value or higher, the second fuel mode drive step switches the first fuel mode to the second fuel mode to drive the vehicle in the second fuel mode.

7. The method of claim 1, wherein in the pressure comparison step, a rail pressure comparison step is performed to check whether the pressure in the fuel supply rail for the first fuel is the fourth reference value or higher, and if the supply rail pressure is the fourth reference value or higher, a tank pressure comparison step is performed to check whether the pressure in the fuel tank is the fifth reference value or higher.

8. The method of claim 7, wherein in the rail pressure comparison step, if the pressure in the fuel supply rail of the first fuel is lower than the fourth reference value, the second fuel mode drive step switches the first fuel mode to the second fuel mode to drive the vehicle in the second fuel mode.

9. The method of claim 7, wherein in the tank pressure comparison step, if the pressure in the fuel tank of the first fuel is lower than the fifth reference value, the second fuel mode drive step switches the first fuel mode to the second fuel mode to drive the vehicle in the second fuel mode.

10. The method of claim 1, wherein in the pressure variation comparison step, a rail pressure variation comparison step is performed to check whether the pressure variation in the fuel supply rail is lower than the sixth reference value, and if the pressure variation in the fuel supply rail is lower than the sixth reference value, a tank pressure variation comparison step is performed to check whether the pressure variation in the fuel tank is lower than the seventh reference value.

11. The method of claim 10, wherein in the rail pressure variation comparison step, if the pressure variation in the fuel supply rail of the first fuel is the sixth reference value or higher, the second fuel mode drive step switches the first fuel mode to the second fuel mode to drive the vehicle in the second fuel mode.

12. The method of claim 10, wherein in the tank pressure variation comparison step, if the pressure variation in the fuel tank of the first fuel is the seventh reference value or higher, the second fuel mode drive step switches the first fuel mode to the second fuel mode to drive the vehicle in the second fuel mode.

13. The method of claim 1, wherein in the pressure variation comparison step, if the pressure variations in the fuel supply rail for the first fuel and in the fuel tank for the first fuel are lower than the sixth and seventh reference values, respectively, the residual fuel amount measurement step is performed.

14. The method of claim 1, wherein the first fuel is liquefied petroleum gas (LPG), and the second fuel is gasoline.
